(19) United States
(12) Patent Application Publication
(10) Pub. No.: US 2015/0076117 A1
(43) Pub. Date: Mar. 19, 2015

(54) METHOD AND DEVICE FOR LONGITUDINAL SEAM WELDING OF PROFILED TUBES ON A TUBE WELDING SYSTEM

(71) Applicants: Ruediger Neugebauer, Duesseldorf (DE); Tobias Schmidt, Duesseldorf (DE)

(72) Inventors: Ruediger Neugebauer, Duesseldorf (DE); Tobias Schmidt, Duesseldorf (DE)

(21) Appl. No.: 14/375,023

(22) PCT Filed: Apr. 17, 2013
(86) PCT No.: PCT/EP2013/001132

§ 371 Date: Jul. 28, 2014

(30) Foreign Application Priority Data
Apr. 18, 2012 (DE) 102012007806.4

(51) Int. Cl. B23K 13/08; H04N 5/33; B23K 31/02; B23K 13/04; B23K 13/02

(52) U.S. Cl. CPC B23K 13/08; B23K 13/046; B23K 13/025; B23K 31/027; H04N 5/33
USPC 219/61.5

(57) ABSTRACT

The invention relates to a method and a device for longitudinal seam welding of profiled tubes on a tube welding system which is connected to a system computer for process control, and to which a slotted tube (5) formed directly in line from a metal strip in a roll forming mill, or a slotted tube shaped from at least one sheet metal panel is supplied, in particular, for welding the longitudinal seam or the longitudinal seams, wherein the tube welding machine is equipped with a means (12) for measuring the temperature of the welding point which is effective at the narrowest location and is occupied by the metal edges of the slotted tube pressed together by means of rollers (8) to form a gap with a tapering V shape. The longitudinal seam welding can be optimised in that temperature fluctuations and shifting of the welding point can be detected by a thermal imaging camera (12) directed onto the vertex of the convergent V-shaped gap with the longitudinal seam being formed, wherein the continuously measured data are processed in the system computer (7) for regulating the welding process in such a way that the welding point (11) at the hottest degree of effectiveness thereof is always located at the same position.

The invention relates to a method and an apparatus for longitudinal-seam welding of profiled tubes in a tube-welding system connected to a computer system for process control, where a slotted tube formed directly in line from a metal strip in a roll forming mill, or a slotted tube reshaped from at least one sheet metal panel, particularly for high-frequency welding of the longitudinal seam, or the longitudinal seams, is supplied, the tube-welding machine being equipped with means for measuring the temperature of the welding point that is effective at the narrowest point occupied by the metal edges of the slotted tube pressed together by rollers to form a gap having a tapering V-shape.

Producing a slotted tube from a strip in a plurality of successively provided steps is known from U.S. Pat. No. 2,110,378, for example. DE 42 15 807 9 [U.S. Pat. No. 5,390,250] describes a tube bending or forming press of frame-type construction with which a sheet-metal plate can be reshaped.

Regardless of which production method is used to generate a slotted tube or, for example, a slotted profiled tube having a rectangular or square cross section, the welding process requires particular care, and the welding point that should be located in the vicinity of the converging point—the vertex or intersection point—of the metal edges located opposite the V-shaped gap, requires constant monitoring. To this end, pyrometers are exclusively used in practice for longitudinal-seam welding of tubes (see company brochure “Optris Infrared Thermometers”). The brochure describes further applications for pyrometers in the processing or production of hot products, like in continuous casting, forging, chill casting, or the like. In connection with the transport of steel melts in ladles, the determination of hottest points on the outer wall of the ladle or container is described by a thermal-imaging camera.

The pyrometers used in longitudinal-seam welding allow detection of the temperature, and if it changes, the welding power or strength, or the position of the inductor can be adjusted in a high-frequency longitudinal-seam welding machine for tubes, for example, in order to counteract welding errors.

However, as found in trials, not only do temperature fluctuations occur during longitudinal-seam welding but the welding point also shifts horizontally and vertically, that is to say, upstream, downstream, upward, and downward.

The object of the invention is to provide a method and an apparatus of the above-mentioned type with which the longitudinal-seam welding of slotted tubes can be optimized.

This object is attained with a method according to the invention in that temperature fluctuations and movement of the welding point are determined by a thermal-imaging camera that is pointed at the vertex of the converging V-shaped gap of the longitudinal seam being formed, the continuously measured data being processed in the system computer for regulating the welding process such that the welding point at its hottest is always in the same position.

In order to improve the weld quality and to avoid the named disadvantages, direct process monitoring by the thermal-imaging camera positioned in a targeted manner at a spacing of about 80 cm from the weld zone is thus carried out for temperature measurement, the thermal-imaging camera also monitoring the entire environment of the welding point, for example, in a measuring field of 310×230 mm, thus detecting movement of the welding point. The stable measurement data of the thermal-imaging camera (infrared camera) can be incorporated into a controller so that by using feedback control the welding procedure can be corrected with precisely defined position of the hottest welding point.

The continuous measuring with high resolution, for example, 30 images per minute, allow simultaneous feedback to the controller of the welding system or machine, with on-screen information to the operator. The operation will instantly be able to recognize a “cold” weld, or receive an error signal, and make a correction. Furthermore, the measurement data can be stored in the computer, and can be evaluated or used for quality management in subsequent welding processes taking into account current production conditions, or can be recorded and documented for quality control or proof of quality.

An apparatus particularly for executing the method according to the invention has a thermal-imaging camera pointed at the area between the welder in the tube-welding machine for detecting the welding point. According to an embodiment of the invention, the thermal-imaging camera is provided on the welding roll stand of the tube-welding machine, advantageously shielded from ambient influences.

The thermal-imaging camera is positioned and shielded such that it remains unaffected by strong electromagnetic fields and also by environmental influences like fog, water, or heat. The environmental influences can be rendered harmless such that, for example, the upper rollers are provided with emulsion-deflecting means, and/or means are provided that blow away or suction off water vapor, or fog, or that the cooling emulsion is fed to the rollers guiding the slotted tube in the welding machine from downstream as viewed in the product travel direction.

Further details and characteristics of the invention are found in the claims and in the following description of an embodiment shown in the drawings. Therein:

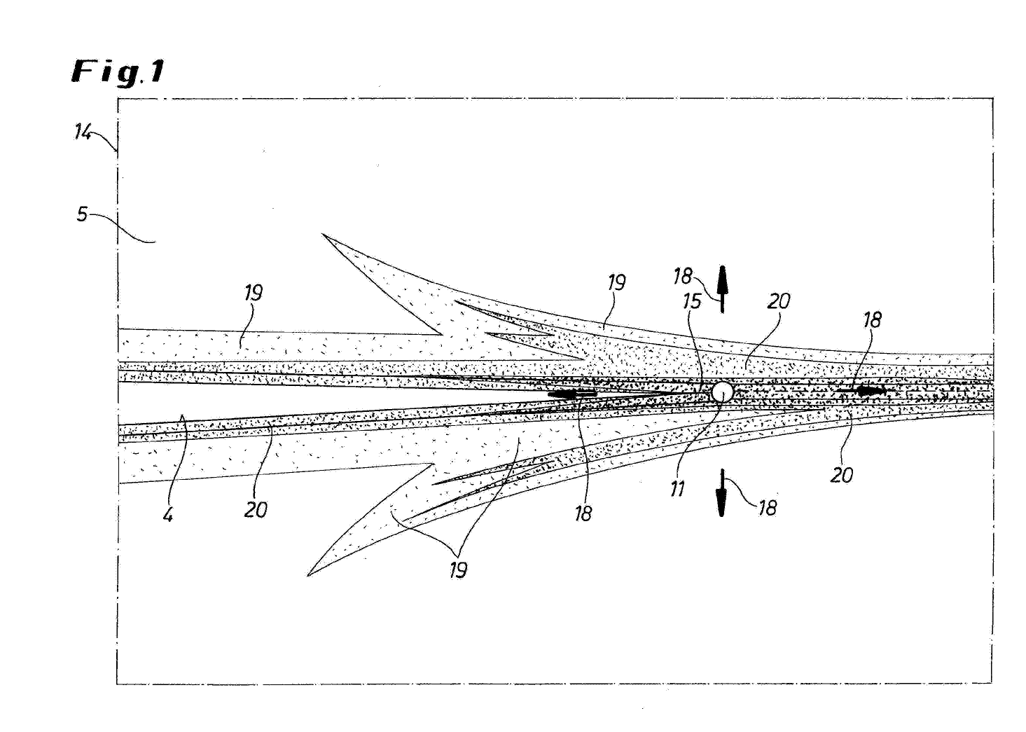

FIG. 1 is an image captured during longitudinal seam tube welding by a thermal-imaging camera detecting the temperature of the welding point, in detail the converging V-shaped gap of a slotted tube showing the (hottest) welding point there; and

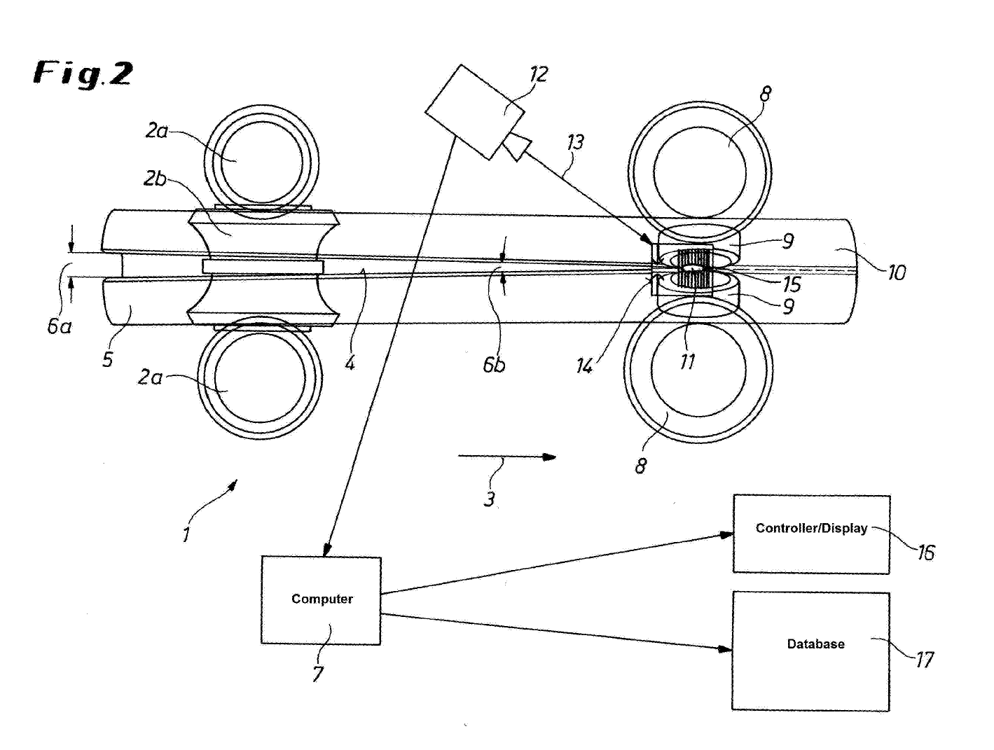

FIG. 2 is a schematic view of a detail of a tube-welding system, a section through the tube-welding machine with a thermal-imaging camera arranged pointing at the welding point, showing approximately the measuring field illustrated in FIG. 1 as a large rectangular in the area of the rear rollers.

A high-frequency longitudinal seam tube-welding system (with inductive and conductive high-frequency welding), for example serves for the manufacture from rolled metal strip of longitudinal-seam welded tubes, such as oil or gas tubes of high quality and having a diameter in the range of 10 to 40 mm and a wall thickness of up to 4 mm and normally comprises a tape preparation, a helical strip supply, a forming or preforming mill, a tube-welding machine, and tube cutter, of which only the end section of a tube-welding machine 1 is illustrated in FIG. 2 in a simplified schematic section.

FIG. 2 shows a piece of a slotted tube 5 gradually deformed from a metal strip by vertical and horizontal rolls 2a and 2b, provided in a HV-array and fed into the tube-welding machine 1 with a progressively narrowing V-shaped gap 4 in the product travel direction shown by arrow 3. As indicated, the angle of the edges of the narrowing V-shaped gap 4 can be determined at measuring points 6a and 6b and the progression can be entered into the system computer 7 or a similar evaluation unit as an actual value. The point of intersection, that is, the vertex of the V-shaped gap 4, is between the rolls 8 of the welding stand at the welder 9. The finished, longitudinal-seam welded tube 10 emerges downstream of the rollers 8.

In order to monitor and optimize the longitudinal-seam welding, in particular the position of the hottest welding point 11 (see FIG. 1), a thermal-imaging camera 12 shielded against environmental influences is provided in the tube-welding machine 1. The thermal-imaging camera is specifically aimed at the vertex of the V-shaped gap 4 in the direction of arrow 13, where it can detect a larger measuring field 14 and hence the hottest spot 15 on the one hand, and particularly also the position of the hottest welding point 11 on the other hand. For regulating the welding process and evaluating the measuring data, the continuously measured data are transmitted to the system computer 7 that as also shown by arrows is connected to the controller 16 for display of the closed control circuit and occurring errors, for example, and to a data base 17 with reference values stored therein from the ongoing production process and/or previous production processes, for example.

FIG. 1 shows a significantly magnified measuring field 14 of the thermal-imaging camera 12, where a cooler zone 19 is shown as lightly dotted, a hotter zone 20 is dotted with somewhat more density, and the hottest zone 15 is, in comparison, very densely dotted. The inserted arrows 18 indicate the direction—to the front, the back, and upward and downward—of the shifting of the hottest welding point 11 that is unavoidable in the welding process. By monitoring and data exchange, the longitudinal-seam welding is regulated in the closed control circuit such that the hottest welding point 11 can always be held at the same optimal position as shown in FIG. 1.

List of Reference Numerals

| | |
|---|---|
| 1 | tube-welding system/machine |
| 2a | vertical roll or roller |
| 2b | horizontal roll or roller |
| 3 | arrow - product travel |
| | direction |
| 4 | V-shaped gap |
| 5 | slotted tube |
| 6a & b | measuring point angle |
| | adjustment |
| 7 | system computer |
| 8 | roll/roller of welding stand |
| 9 | welder |
| 10 | finished, longitudinal seam |
| | welded tube |
| 11 | hottest welding point |
| 12 | thermal-imaging camera |
| 13 | arrow |
| 14 | measuring field |
| 15 | hottest zone |
| 16 | controller |
| 17 | data base |
| 18 | arrow |
| 19 | cooler zone |
| 20 | hotter zone |

1. In a method for longitudinal-seam welding of profiled tubes in a tube-welding system connected to a system computer for process control, where a slotted tube formed directly in line from a metal strip in a roll forming mill, or a slotted tube reshaped from at least one sheet metal panel, particularly for high-frequency welding of the longitudinal seam or seams, is supplied, the tube-welding machine being equipped with means for measuring the temperature of a welding point at the narrowest point formed by metal edges of the slotted tube pressed together by rollers to form a gap having a tapering V-shape, the improvement comprising the steps of:
continuously determining temperature fluctuations and a shifting of the welding point using a thermal-imaging camera aimed at the vertex of the converging V-shaped gap where the longitudinal seam is formed and producing an output of continuously measured image data; and
processing the continuously measured data from the camera in the system computer for regulating the welding process such that the welding point at its hottest is always in the same position.

2. In an apparatus for longitudinal-seam welding of profiled tubes in a tube-welding system connected to a system computer for process control, where a slotted tube formed directly in line from a metal strip in a roll forming mill, or a slotted tube reshaped from at least one sheet metal panel, particularly for high-frequency welding of the longitudinal seam or seams, is supplied, the tube-welding machine being equipped with means for measuring the temperature of a welding point at the narrowest point formed by metal edges of the slotted tube pressed together by rollers to form a gap having a tapering V-shape, the improvement comprising:
a thermal-imaging camera provided in the tube-welding machine and aimed at the area between the welder for detecting the hottest welding point.

3. The apparatus according to claim 2, wherein the thermal-imaging camera is shielded from environmental influences.
